(19) United States
(12) Patent Application Publication
(10) Pub. No.: US 2015/0263356 A1
(43) Pub. Date: Sep. 17, 2015

(54) METHOD OF PROCESSING A POROUS ARTICLE

(71) Applicant: UTC POWER CORPORATION, South Windsor, CT (US)

(72) Inventors: Glenn Michael Allen, Vernon, CT (US); Steven W. Gronda, Feeding Hills, MA (US); Daniel Thomas Swanson, Unionville, CT (US)

(21) Appl. No.: 14/425,261

(22) PCT Filed: Sep. 6, 2012
(86) PCT No.: PCT/US2012/053827

§ 371 Date: Mar. 2, 2015

(51) Int. Cl. H01M 8/02; B29C 67/24; C01B 31/02

(52) U.S. Cl. CPC H01M 8/0234; C01B 31/02; B29C 67/24; H01M 8/0243; H01M 8/0239; B29K 2061/04

(57) ABSTRACT

A method of processing a porous article includes distributing a blended powder material including loose electrically conductive particles and loose resin particles into a mold. The blended powder material is consolidated within the mold under a molding pressure and a molding temperature into a consolidated article. The loose resin particles of the blended powder material are selected to be within a predefined particle size distribution to control a physical property of the porous article.

### STATEMENT REGARDING FEDERALLY SPONSORED RESEARCH OR DEVELOPMENT

This invention was made with government support under contract number CA-04-7003-00 awarded by Federal Transit Authority. The government has certain rights in the invention.

### BACKGROUND

This disclosure relates to techniques for forming porous articles, such as porous water transport plates for fuel cells.

A porous article, such as a water transport plate, is typically molded from a powdered or granular material. The molding process generally includes placing the powdered or granular material into a mold and consolidating the material under heat and pressure. The article may be carbonized in a further step, or used essentially as-is without carbonization.

### SUMMARY

A method of processing a porous article according to an exemplary aspect of the present disclosure includes distributing a blended powder material including loose electrically conductive particles and loose resin particles into a mold, consolidating the blended powder material within the mold under a molding pressure and a molding temperature into a consolidated article, and selecting the loose resin particles in the distributing step to be within a predefined particle size distribution to control a physical property of the porous article.

A further method of processing a porous article according to an exemplary aspect of the present disclosure includes distributing a blended powder material including loose electrically conductive particles and loose resin particles into a mold, consolidating the blended powder material within the mold under a molding pressure and a molding temperature into a porous consolidated article, carbonizing the resin of the porous consolidated article to form a final porous carbon article and, for a given predefined minimum strength requirement of the porous carbon article and a given process parameter window of the consolidating step that influences the strength of the porous carbon article, expanding the processing parameter window while still meeting the predefined minimum strength requirement by selecting the loose resin particles in the distributing step to be within a predefined particle size distribution.

The various features and advantages of the disclosed examples will become apparent to those skilled in the art from the following detailed description. The drawings that accompany the detailed description can be briefly described as follows.

### BRIEF DESCRIPTION OF THE DRAWINGS

FIG. 1 illustrates an example method for processing a porous article.

FIG. 2 illustrates another example method for processing a porous article.

FIG. 3 illustrates a graph of strength versus density.

### DETAILED DESCRIPTION

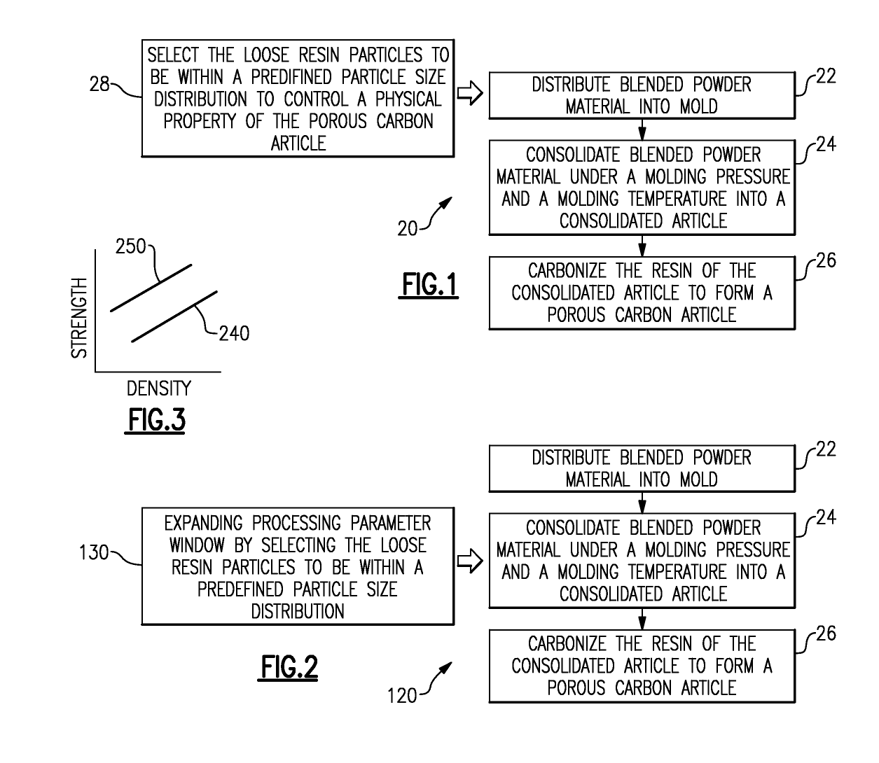

FIG. 1 illustrates selected steps of an example method 20 for processing a porous article. It is to be appreciated that the method 20 may be used to form any desirable type of porous article that is molded from a powdered starting resin material. In one example, the porous article is a porous water transport plate, for use in a fuel cell, and includes reactant gas channels on one or both sides.

For reasons that are heretofore unknown, one or more physical properties of porous articles can vary outside of a specified requirement. As an example based on carbon water transport plates, the strength of the plates has been found to vary. A similar phenomenon would be expected for other porous articles. As will be discussed in further detail, it has been discovered that a particle size distribution of the powdered starting resin used to mold porous articles influences one or more physical properties of the porous article. Thus, a particle size distribution is predefined to control a physical property of the porous article.

In the illustrated example, the method 20 includes a distribution step 22, a consolidation step 24, an optional carbonization step 26 and a selection step 28, which will each be described in more detail below.

In one embodiment, the distribution step 22 includes distributing a blended powder material that includes loose electrically conductive particles and loose resin particles into a mold. The consolidation step 24 includes consolidating the blended powder material within the mold under a molding pressure and a molding temperature into a consolidated article. The optional carbonization step 26 includes carbonizing the resin of the consolidated article to form a porous carbon article. In general, the carbonization increases porosity, enhances electrical conductivity and removes contaminates/organics that may be in the resin material.

In further embodiments, the electrically conductive particles are or include graphite particles and the resin particles are or include a thermosetting resin. In a further example, the thermosetting resin is a phenolic resin. In a further example, the blended powder material includes only the loose electrically conductive particles and loose resin particles, along with any impurities in the materials. In one example, the blended powder material has a composition of 65-95% weight of the loose electrically conductive particles and a balance of the loose resin particles. In a further example, the blended powder material has a composition of 80-85% weight of the loose electrically conductive particles and a balance of the loose resin particles.

The particle size distribution of the loose resin particles used in the blended powder material influences a physical property or properties of the porous carbon article. As an example, the particle size distribution of the loose resin particles influences the strength of the porous carbon article. In a further example, the strength is the bending strength of the porous carbon article. In this regard, the selection step 28 includes selecting the loose resin particles in the distribution step 22 to be within a predefined particle size distribution in order to control the physical property or properties of the porous carbon article.

In a further embodiment, the selected predefined particle size distribution includes 95% by volume of the loose resin particles being 22 micrometers or less in average diameter. In a further example, the size distribution includes 95% by volume of the loose resin particles being 10 micrometers or less in average diameter. In one example, the size distribution includes 95% by volume of the loose resin particles having an average diameter of 6.5 micrometers. In a further example, the standard deviation of the particle size distribution is relatively narrow. In one example where the predefined particle size distribution includes 95% by volume of the loose resin particles being 22 micrometers or less in average diameter, the standard deviation is 6 micrometers or less. In another example where the predefined particle size distribution includes 95% by volume of the loose resin particles being 10 micrometers or less in average diameter, such as 6.5 micrometers in average diameter, the standard deviation is 4 micrometers or less. The general trend of particle size distribution is that smaller average particles size distribution increases the strength of the porous article.

In a further embodiment of the distribution step 22 of the method 20, the blended powder material is distributed into a mold that will be used to form the porous consolidated article. As can be appreciated, the mold may include a cavity that is contoured in the shape of the desired final porous article, but is not limited to any particular shape. In the example of a water transport plate that has channels on one or both sides, the mold is contoured to form the channels. Alternatively, the channels are machined into the porous consolidated article or into the article after carbonization.

After distributing of the blended powder material into the mold, the mold is closed with a suitable cover or a mating mold tool, and subjected to a molding pressure and a molding temperature to form a consolidated article. In one embodiment, the molding pressure is approximately 0.5-1000 pounds per square inch (approximately 3.5-6895 kilopascals). The molding pressure may be maintained throughout the heating of the mold, or alternatively, the pressure may be adjusted over a pressure profile while heating the mold. In a further example, an initial molding pressure is 40 pounds per square inch (approximately 276 kilopascals), and the pressure is increased to 560 pounds per square inch (approximately 3861 kilopascals).

As the temperature of the mold increases, the loose resin particles of the blended powder material soften and liquefy. The liquefied resin flows under the molding pressure and uniformly distributes the resin material among the electrically conductive particles. In one example that utilizes a thermosetting resin, upon further heating a curing temperature is reached, at which time the resin cross-links. The consolidated article may be held for a predetermined amount of time at the curing temperature to complete the curing process. For phenolic thermosetting resins, the curing temperature may be 130-200° C. The pressure may then be released and either the consolidated article removed from the mold or the mold cooled before removing the consolidated article.

Once cured, the consolidated article is then carbonized in the carbonization step 26. The temperature and atmospheric conditions used for the carbonization step 26 may vary depending upon the type of resin used. In one example where the resin is a phenolic resin, the carbonization temperature is greater than 800° C., such as about 900° C., and the treatment atmosphere is an inert, non-oxidizing atmosphere, such as argon. Under such conditions, the resin thermally decomposes or “chars” into a carbonaceous material such that the electrically conductive particles and the carbonaceous material (char) are bonded together in the desired shape of a porous carbon article.

Optionally, the porous carbon article is further subjected to post-treatment processing as appropriate for the given article. In one example, if the porous carbon article is a porous water transport plate for use in a fuel cell, the article may be subsequently treated to apply a hydrophilic material through the porosity of the article to facilitate moisture distribution through the plate. As an example, the hydrophilic material includes tin oxide that is applied using a known wet chemistry acid technique.

The selection of the loose resin particles to be within the predefined particle size distribution to control the physical property, such as the strength, of the porous carbon article allows enhancement of the physical property or, alternatively, expansion of one or more processing parameter windows within the method 20. Turning to FIG. 2, a modified method 120 is shown, which is similar to the method 20 shown in FIG. 1 with respect to the distribution step 22, the consolidation step 24, and the carbonization step 26. In this example, the method 120 includes an expansion step 130 in which one or more processing parameter windows are expanded in the consolidation step 24. That is, by selecting the loose resin particles of the blended powder material to be within the predefined particle sized distribution the property or properties of the porous carbon article are enhanced. However, with regard to minimum property requirements, instead of enhancing the property, one or more processing parameter windows may be expanded while still meeting the minimum requirement and thereby allow greater latitude in the design of the process and cost reduction, for example.

As an example for a given predefined minimum strength requirement of the porous carbon article and a given process parameter window of the consolidation step 22 that influences the strength of the porous carbon article, the processing parameter window is expanded while still meeting the predefined strength requirement by selecting the loose resin particles of the blended powder material to be within the predefined particle size distribution.

In a further example, the processing parameter window that is expanded includes one or more of the molding temperature, the molding pressure and density of the porous carbon article. Put another way, expanding the processing parameter window would normally debit the strength. However, by using the predefined particle size distribution, the processing parameter window or windows can be expanded while at least maintaining the same strength relative to the unexpanded processing parameter window or windows. The term “expanded” or variations thereof used to describe the processing parameter windows refers to the use of broader process setting ranges. For instance, if the molding pressure of a given process is initially 10-15 pounds per square inch, an expanded window would be 8-17 pounds per square inch. In a further example, the expanded processing parameter window enlarges at least one end of the window range by 10% or more, or alternatively by 30% or more. Such expansions are typically not possible without sacrificing strength of the porous article.

The expansion of the processing parameter window or windows is further illustrated in FIG. 3, which shows a graph of bending strength of porous articles versus density of the porous articles. In FIG. 3, the line 240 represents the strength trend of a porous article that is formed from loose resin particles that are outside the disclosed predefined particle size distribution. Line 250 represents the strength trend of a porous article made using loose resin particles within the disclosed predefined particle size distribution. As shown, using particles within the predefined particle size distribution shifts the strength upwards. Moreover, for a given strength, a less dense porous article is required to achieve that strength. Similarly, for a given density, the porous articles made using particles within the predefined particle size distribution are stronger than porous articles made using particles that are outside the disclosed predefined particle size distribution. For instance, a porous article that is made without using particles within the predefined particle size distribution disclosed herein must meet a target density of 1.57-1.63 grams per cubic centimeters to meet a given strength target. However, for a porous article that is made by using particles within the predefined particle size distribution disclosed herein, the target density is expanded to 1.55-1.63 grams per cubic centimeter. This represents an increase in target density range of 33%.

Although a combination of features is shown in the illustrated examples, not all of them need to be combined to realize the benefits of various embodiments of this disclosure. In other words, a system designed according to an embodiment of this disclosure will not necessarily include all of the features shown in any one of the Figures or all of the portions schematically shown in the Figures. Moreover, selected features of one example embodiment may be combined with selected features of other example embodiments.

The preceding description is exemplary rather than limiting in nature. Variations and modifications to the disclosed examples may become apparent to those skilled in the art that do not necessarily depart from the essence of this disclosure. The scope of legal protection given to this disclosure can only be determined by studying the following claims.

What is claimed is:

1. A method of processing a porous article, the method comprising:
(a) distributing a blended powder material including loose electrically conductive particles and loose resin particles into a mold;
(b) consolidating the blended powder material within the mold under a molding pressure and a molding temperature into a consolidated article; and
(c) selecting the loose resin particles in step (a) to be within a predefined particle size distribution to control a physical property of the porous article.

2. The method as recited in claim 1, wherein the predefined particle size distribution includes 95% by volume of the loose resin particles being less than 22 micrometers in average diameter.

3. The method as recited in claim 1, wherein the physical property is strength.

4. The method as recited in claim 1, wherein the physical property is bending strength.

5. The method as recited in claim 1, wherein, for a given predefined minimum strength requirement of the porous article and a given process parameter window of the consolidating of step (b) which influences the strength of the porous article, expanding the processing parameter window while still maintaining the predefined minimum strength requirement by selecting the loose resin particles in step (a) to be within a predefined particle size distribution.

6. The method as recited in claim 5, wherein the processing parameter window is the molding temperature.

7. The method as recited in claim 5, wherein the processing parameter window is the molding pressure.

8. The method as recited in claim 5, wherein the processing parameter window is density of the porous article.

9. The method as recited in claim 1, wherein the blended powder material has a composition of 65-95% weight of the loose electrically conductive particles and a balance of the loose resin particles.

10. The method as recited in claim 1, wherein the loose electrically conductive particles are graphite particles.

11. The method as recited in claim 1, wherein the loose resin particles are thermosetting resin particles.

12. The method as recited in claim 1, wherein the loose resin particles are phenolic particles.

13. The method as recited in claim 1, including carbonizing the resin of the consolidated article to transform the porous article into a porous carbon article.

14. The method as recited in claim 13, wherein the carbonizing includes thermally decomposing the resin.

15. The method as recited in claim 1, including treating the porous article to apply a hydrophilic coating through the porosity.

16. A method of processing a porous article, the method comprising:
(a) distributing a blended powder material including loose electrically conductive particles and loose resin particles into a mold;
(b) consolidating the blended powder material within the mold under a molding pressure and a molding temperature into a consolidated article;
(c) carbonizing the resin of the consolidated article to form a porous carbon article; and
(d) for a given predefined minimum strength requirement of the porous carbon article and a given process parameter window of the consolidating of step (b) that influences the strength of the porous carbon article, expanding the processing parameter window while still meeting the predefined minimum strength requirement by selecting the loose resin particles in step (a) to be within a predefined particle size distribution.

17. The method as recited in claim 16, wherein the predefined particle size distribution includes 95% by volume of the loose resin particles being less than 22 micrometers in average diameter.

18. The method as recited in claim 16, including selecting the loose resin particles in step (a) to be within the predefined particle size distribution to control a physical property of the porous carbon article.
